(19) United States
(12) Patent Application Publication
(10) Pub. No.: US 2025/0330610 A1
(43) Pub. Date: Oct. 23, 2025

(54) SECONDARY SPATIAL MERGE CANDIDATES

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 19/176,061

(22) Filed: Apr. 10, 2025

Related U.S. Application Data
(60) Provisional application No. 63/635,349, filed on Apr. 17, 2024.

(51) Int. Cl. H04N 19/139; H04N 19/176

(52) U.S. Cl. CPC H04N 19/139; H04N 19/176

(57) ABSTRACT

An apparatus includes at least one processor; and at least one memory storing instructions that, when executed by the at least one processor, cause the apparatus at least to: determine whether a number of spatial merge candidates comprising motion information derived from primary neighboring blocks of a current coding unit is less than a number of allowed spatial merge candidates; determine a spatial merge candidate comprising motion information derived from at least one secondary neighboring block of the current coding unit, in response to the number of spatial merge candidates comprising motion information derived from the primary neighboring blocks of the current coding unit being less than the number of allowed spatial merge candidates; and code the current coding unit using the spatial merge candidate.

### TECHNICAL FIELD

The examples and non-limiting embodiments relate generally to multimedia transport and, more particularly, to secondary spatial merge candidates.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 shows a current CU (X) with its five spatial neighboring positions.

FIG. 2 shows an example where motion information at a neighboring above position B0 is not available, and hence, motion information at an above-left position (AB) is included among spatial merge candidates in the merge candidate list.

FIG. 3 shows an example where for a current CU (X), there are primary and secondary neighboring 4×4 blocks on the left side of the current CU (X) and above the current CU (X).

FIG. 4 shows an example where motion information of a secondary neighboring block B4 is included as a spatial merge candidate.

FIG. 5 shows an example where motion information of a secondary neighboring block A4 is included as a spatial merge candidate.

FIG. 6 shows an example where motion information of a secondary neighboring block By is included as a spatial merge candidate.

FIG. 7 shows an example where motion information of a secondary neighboring block Ax is included as a spatial merge candidate.

FIG. 8 shows schematically a user equipment suitable for employing embodiments of the examples described herein.

FIG. 9 is a block diagram illustrating a system in accordance with an example.

FIG. 10 is an example apparatus configured to implement the examples described herein.

FIG. 11 shows a representation of an example of non-volatile memory media used to store instructions that implement the examples described herein.

FIG. 12 shows an encoder according to an embodiment.

FIG. 13 shows a decoder according to an embodiment.

FIG. 14 is an example method, based on the examples described herein.

FIG. 15 is an example method, based on the examples described herein.

### DETAILED DESCRIPTION OF EXAMPLE EMBODIMENTS

Versatile Video Coding (VVC) is a new international video coding standard, and Enhanced Compression Model (ECM), built on top of VVC, is potentially a future video coding standard currently under development sponsored by JVET. Both VVC and ECM are block-based video coding standards, where an input picture is divided into Coding Tree Units (CTUs), and each CTU may be further split into Coding Units (CUs). A CU (or block) is coded in either inter-coding mode or intra-coding mode. If the block is in inter-coding mode, the encoder searches for a temporal prediction block in reference picture(s) and signals the decoder on how to find the same prediction block in reference picture(s) at the decoder end. If the block is in intra-coding mode, the encoder constructs a spatial prediction block from the current picture and signals the decoder on how to form the same spatial prediction block from the current picture at the decoder end.

For a current inter-CU in a current picture, the associated temporal prediction block in reference pictures is represented by motion information (e.g., motion vectors, reference pictures, reference picture lists) with respect to the current CU in the current picture. The encoder signals the motion information to the decoder, and the decoder uses the motion information to form the temporal prediction block from reference pictures.

In VVC and ECM, for a current CU, its motion information may consist of two parts: motion information prediction (e.g. motion vector prediction-MVP) and motion information delta (e.g. motion vector delta-MVD). For a current CU, its motion information prediction is derived from the motion information of the past inter coded CUs in the current picture or in reference pictures, and on the other hand, the motion information delta is often coded in an explicit manner.

VVC and ECM supports many new and refined coding tools for deriving the motion information prediction for a current CU. One of the coding tools is merge prediction, in which for a current CU, both encoder and decoder construct a same list of merge candidates. The merge candidates hold the motion information of the past inter coded CUs around the current CU both spatially and temporally. Encoder selects a merge candidate (motion information) from the merge candidate list for the current CU, and signals decoder which merge candidate in the merge candidate list to be used for the current CU.

For a current CU in a current picture, a merge candidate list is constructed by including the following types of candidates (1-7): 1) Spatial merge candidates, 2) Temporal merge candidates, 3) Non-adjacent merge candidates, 4) History-based merge candidates, 5) Pairwise average merge candidates, 6) History-based merge candidates from Affine HMVP, and 7) Zero MV merge candidates.

For a current CU, the spatial merge candidates (holding the motion information including motion vectors, reference pictures, reference picture lists) are derived from the motion information of the current CU's above, left, above-right, bottom-left and above-left neighboring positions.

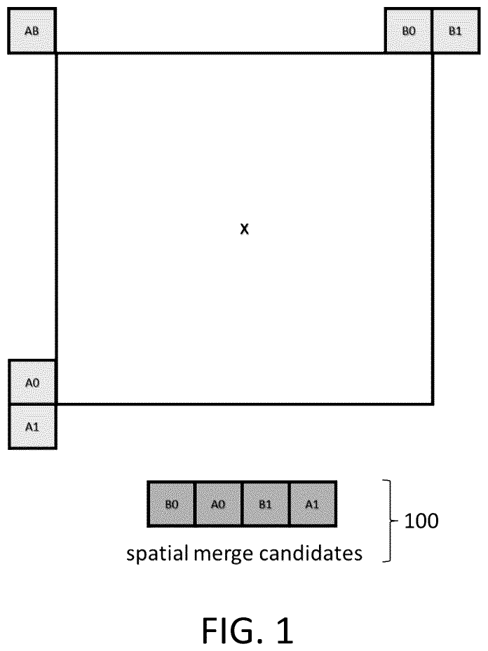

FIG. 1 shows a current CU (X) with its five neighboring positions: above (B0), left (A0), above-right (B1), bottom-left (A1) and above-left (AB). In the current design of VVC and ECM, a current CU can have up to four spatial merge candidates from the five spatial neighboring positions. Specifically, the spatial merge candidates in the list 100 are first obtained from the neighboring positions B0, A0, B1, and A1, as shown in FIG. 1.

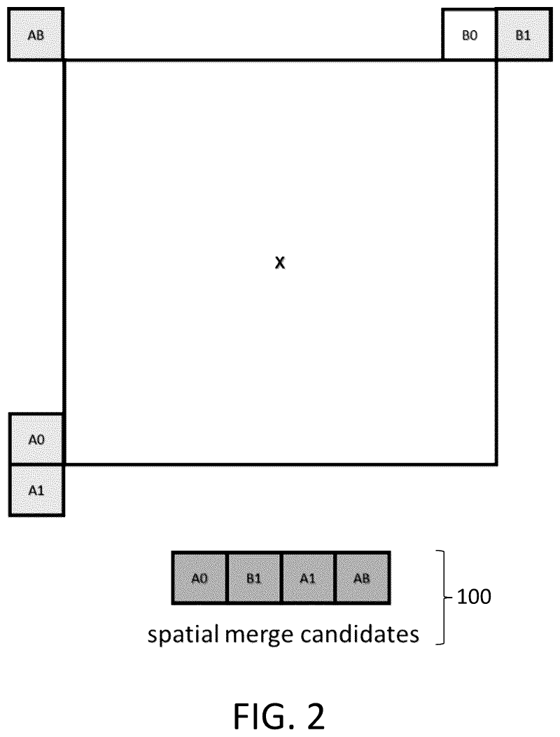

If motion information at one or more of B0, A0, B1 and A1 is not available, motion information at AB is included as one of spatial merge candidates. FIG. 2 shows an example, where motion information at BO is not available, and hence, motion information at AB is included as a spatial merge candidate to the list 100.

For a current CU, it is possible that motion information at one or more of its five spatial neighboring positions may not be available. For example, the CUS covering the one or more of the five neighboring positions may not be coded in inter mode or outside of picture boundaries, and thus motion information for those CUs is not available. The one or more of the five neighboring positions covered by those CUs do not have motion information either.

Described herein are methods to extend the positions from which additional spatial merge candidates can be obtained for a current CU, if there is a need.

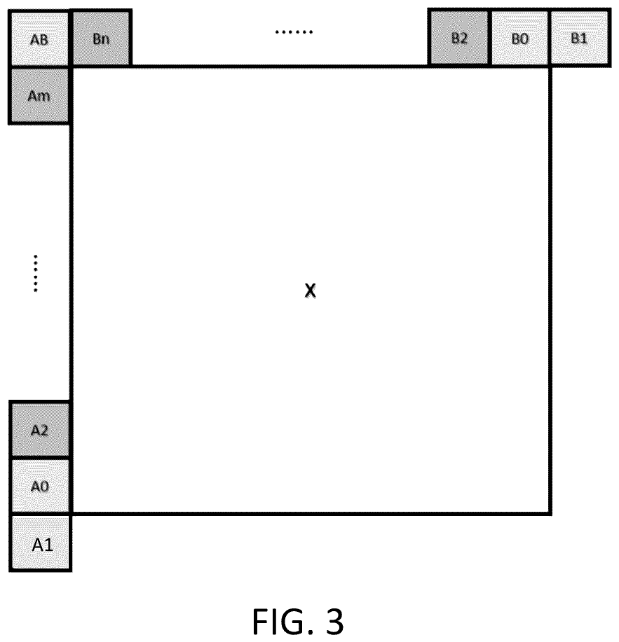

In VVC and ECM, the smallest width or height is 4. Hence, referring to FIG. 3, a current CU may be considered to be neighbored by a number of neighboring blocks of the smallest size (e.g. 4×4 in VVC and ECM) A0, A1, . . . , Am on the left, and also by a number of neighboring blocks of the smallest size B0, B1, . . . , Bn above. Additionally, at the above-left corner is a block of the smallest size denoted as AB. The number of neighboring blocks for a current CU depends on the size of the current CU. For example, for a current CU with width W and height H and the smallest block width and height equal to 4, n is equal to W/4 and m is equal to H/4.

If the neighboring blocks A0, A1, B0, B1 and AB are considered as primary neighboring blocks for the current CU (X), other neighboring blocks A2, . . . , Am and B2, . . . , Bn may be considered as secondary neighboring blocks for the current CU.

Thus, FIG. 3 shows that for a current CU (X), there are primary and secondary neighboring blocks on the left side of and above the current CU (X).

For a current CU, the spatial merge candidates (motion information) are first derived from the primary neighboring blocks (e.g., A0, A1, B0, B1 and AB) as specified in VVC and ECM.

If two or more of the five primary neighboring blocks are not available or not coded in inter mode, or identical (or similar) motion information from the five primary neighboring blocks exists, the available spatial merge candidate positions (e.g. there are up to 4 positions for spatial merge candidates in VVC and ECM) for the current CU may not be completely filled. In such cases, the unfilled spatial merge candidate positions are then open to the secondary neighboring blocks A2, . . . , Am on the left side of the current CU and/or secondary neighboring blocks B2, . . . , Bn above the current CU.

Let N_{MAX} be the max number of spatial merge candidates allowed and N_{SMC} be the number of spatial merge candidates derived from the primary neighboring blocks. If N_{SMC}<N_{MAX}, there are (N_{MAX}−N_{SMC}) unfilled spatial merge candidate positions. These unfilled merge candidate positions can be filled with unique motion information derived from secondary neighboring blocks, if available.

In one embodiment, for a current CU, if N_{SMC}<N_{MAX}, an encoder and decoder may check the motion information of secondary neighboring blocks A2, . . . , Am and B2, . . . , Bn in a preset order. If at least one unique motion information is found, the at least one unique motion information is added in the merge candidate list as spatial merge candidate to fill the (N_{MAX}−N_{SMC}) unfilled spatial merge candidate positions.

In one embodiment, for a current CU, if N_{SMC}<N_{MAX} and two or more of the above primary neighboring blocks B0, B1 and AB are not available or not coded in inter mode, encoder and decoder may check the motion information of secondary neighboring blocks (B2, . . . , Bn) above the current CU in a preset order. If at least one unique motion information is found, the at least one unique motion information is added in the merge candidate list as spatial merge candidate to fill the (N_{MAX}−N_{SMC}) unfilled spatial merge candidate positions. If no unique motion information is found from the above secondary neighboring blocks (B2, . . . , Bn), encoder and decoder may extend the checking of motion information to the left secondary neighboring blocks (A2, . . . , Am).

In one embodiment, for a current CU, if N_{SMC}<N_{MAX} and two or more of the left primary neighboring blocks A0, A1 and AB are not available or not coded in inter mode, encoder and decoder may check the motion information of secondary neighboring blocks (A2, . . . , Am) on the left side of the current CU in a preset order. If at least one unique motion information is found, the at least one unique motion information is added in the merge candidate list as spatial merge candidate to fill the (N_{MAX}−N_{SMC}) unfilled spatial merge candidate positions. If no unique motion information is found from the left secondary neighboring blocks (A2, . . . , Am), encoder and decoder may extend the checking of motion information to the above secondary neighboring blocks (B2, . . . , Bn).

In one embodiment, for a current CU, if N_{SMC}<N_{MAX} and two or more of the above primary neighboring blocks BO, B1 and AB are not available or not coded in inter mode, encoder and decoder may check the motion information of secondary neighboring blocks above the current CU in the order of B2, . . . , Bn. If at least one unique motion information is found, the at least one unique motion information is added in the merge candidate list as spatial merge candidate to fill the (N_{MAX}−N_{SMC}) unfilled spatial merge candidate positions. If no unique motion information is found from the above secondary neighboring blocks (B2, . . . , Bn), encoder and decoder may extend the checking of motion information to the left secondary neighboring blocks (A2, . . . , Am).

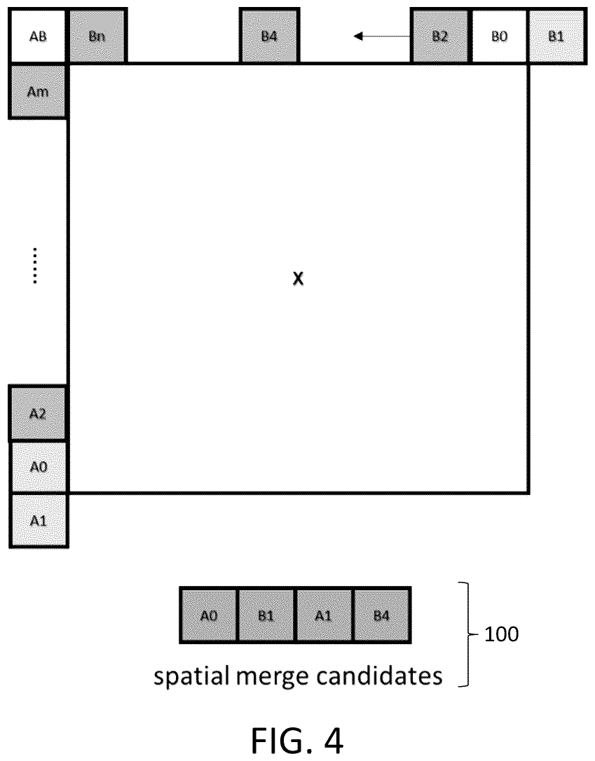

FIG. 4 shows an example, where N_{SMC}<N_{MAX} and motion information at BO and AB are not available. Secondary neighboring blocks above the current CU (X) are checked starting from B2. In this example, B4 happens to be the first block with unique motion information. Hence, the unique motion information of block B4 is included as a spatial merge candidate within the list 100, as shown in FIG. 4. Thus, FIG. 4 shows motion information of secondary neighboring block of B4 being included as a spatial merge candidate.

In one embodiment, for a current CU, if N_{SMC}<N_{MAX} and two or more of the left primary neighboring blocks A0, A1 and AB are not available or not coded in inter mode, encoder and decoder may check the motion information of secondary neighboring blocks on the left side of the current CU in the order of A2, . . . , Am. If at least one unique motion information is found, the at least one unique motion information is added in the merge candidate list as spatial merge candidate to fill the (N_{MAX}−N_{SMC}) unfilled spatial merge candidate positions. If no unique motion information is found from the left secondary neighboring blocks (A2, . . . , Am), encoder and decoder may extend the checking of motion information to the above secondary neighboring blocks (B2, . . . , Bn).

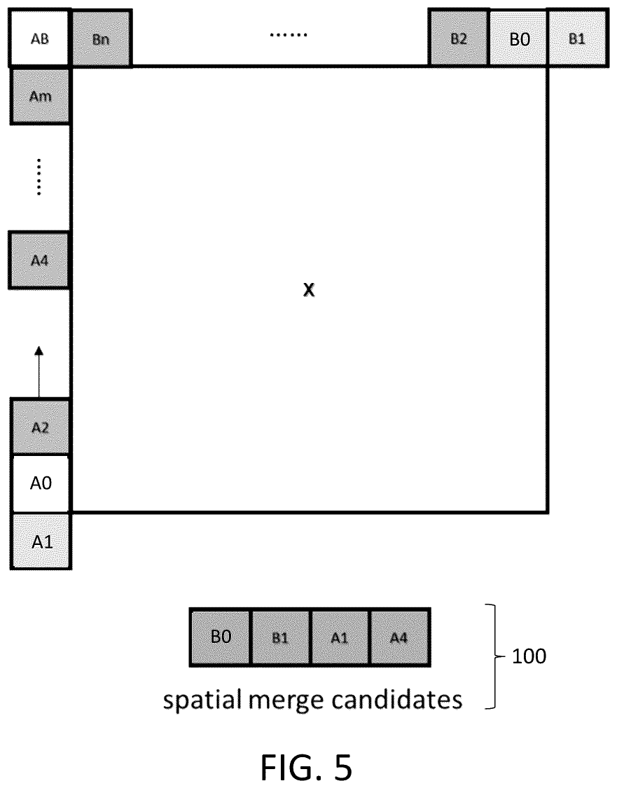

FIG. 5 shows an example, where N_{SMC}<N_{MAX} and motion information at A0 and AB are not available. Secondary neighboring blocks on the left side of the current CU are checked starting from A2. In this example, A4 comes to be the first block with unique motion information. Hence, the unique motion information of block A4 is included as spatial merge candidate in the list 100, as shown in FIG. 5.

In one embodiment, for a current CU, if N_{SMC}<N_{MAX} and two or more of the above primary neighboring blocks B0, B1 and AB are not available or not coded in inter mode, encoder and decoder may check the motion information of secondary neighboring blocks above the current CU. This process begins with the middle block between BO and AB and extends to other above secondary neighboring blocks on both the left and the right sides of the middle block alternatively. If at least one unique motion information is found, the at least one unique motion information is added in the merge candidate list as spatial merge candidate to fill the (N_{MAX}−N_{SMC}) unfilled spatial merge candidate positions. If no unique motion information is found from the above secondary neighboring blocks (B2, . . . , Bn), encoder and decoder may extend the checking of motion information to the left secondary neighboring blocks (A2, . . . , Am).

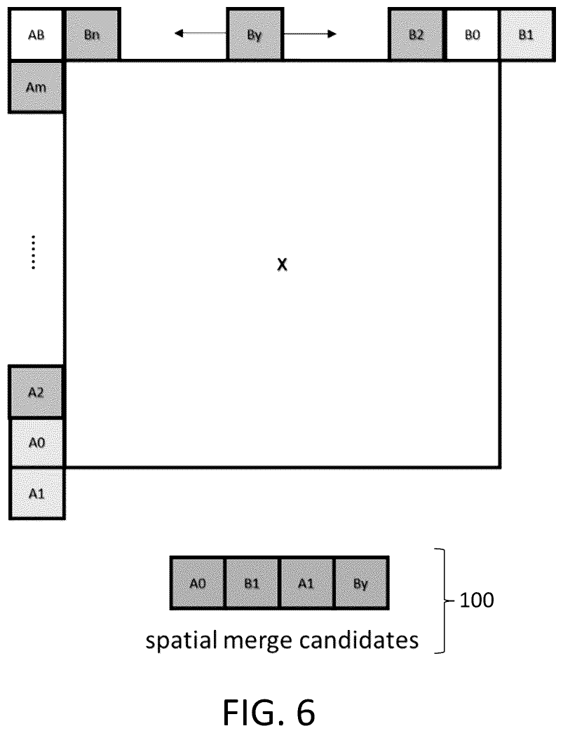

FIG. 6 shows an example, where N_{SMC}<N_{MAX} and motion information at BO and AB are not available. Secondary neighboring blocks above the current CU are checked starting with the middle block between B0 and AB. In this example, By happens to be the first block with unique motion information. Hence, the unique motion information of block By is included as a spatial merge candidate in the list 100, as shown in FIG. 6.

In one embodiment, for a current CU, if N_{SMC}<N_{MAX} and two or more of the left primary neighboring blocks A0, A1 and AB are not available or not coded in inter mode, encoder and decoder may check the motion information of secondary neighboring blocks on the left side of the current CU. This process begins with the middle block between A0 and AB and extends to other left secondary neighboring blocks, both above and below the middle block alternatively. If at least one unique motion information is found, the at least one unique motion information is added in the merge candidate list as spatial merge candidate to fill the (N_{MAX}−N_{SMC}) unfilled spatial merge candidate positions. If no unique motion information is found from the left secondary neighboring blocks (A2, . . . , Am), encoder and decoder may extend the checking of motion information to the above secondary neighboring blocks (B2, . . . , Bn).

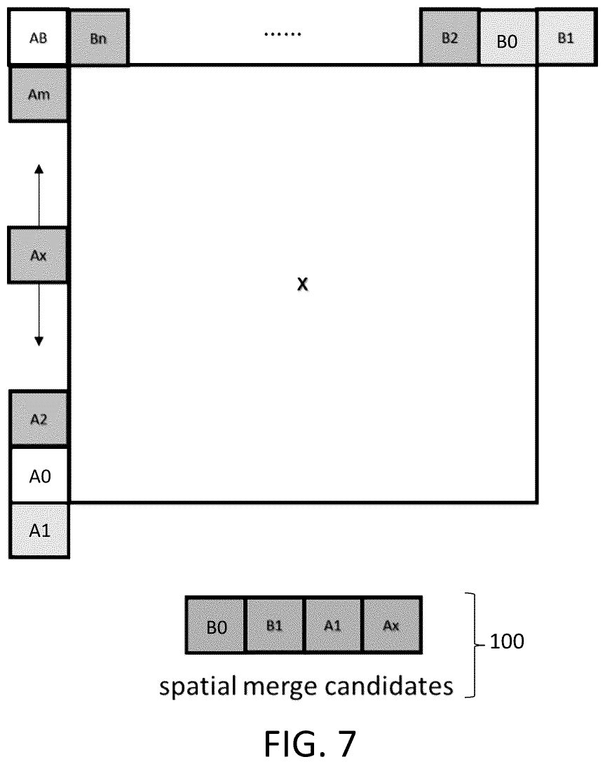

FIG. 7 shows an example, where N_{SMC}<N_{MAX} and motion information at A0 and AB are not available. Secondary neighboring blocks on the left side of the current CU are checked starting with the middle block Ax between A0 and AB. In this example, Ax comes to be the first block with unique motion information. Hence, the unique motion information of block Ax is included as spatial merge candidate in the list 100, as shown in FIG. 7.

Similar concepts and the embodiments above can also apply to spatial merge candidates for CUs in IBC mode and/or spatial merge candidates for CUs in affine mode.

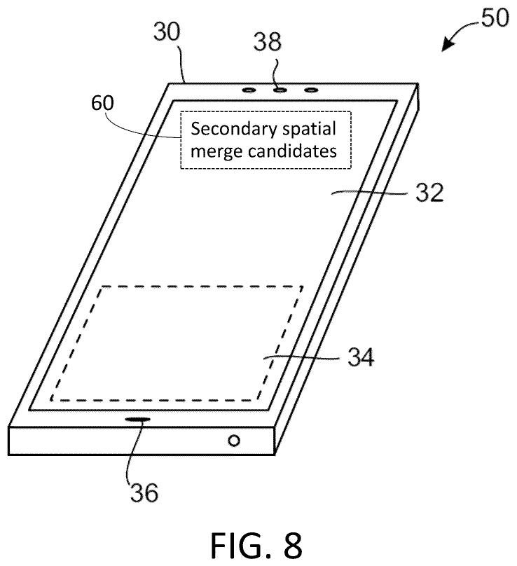

FIG. 8 shows a layout of an apparatus 50 according to an example embodiment. The electronic device 50 may for example be a mobile terminal or user equipment of a wireless communication system, a sensor device, a tag, or other lower power device. However, the embodiments of the examples described herein may be implemented within any electronic device or apparatus which may encode or decode multimedia content.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

As shown in FIG. 8, secondary spatial merge candidates 60 may implement the examples described herein related to determining secondary spatial merge candidates.

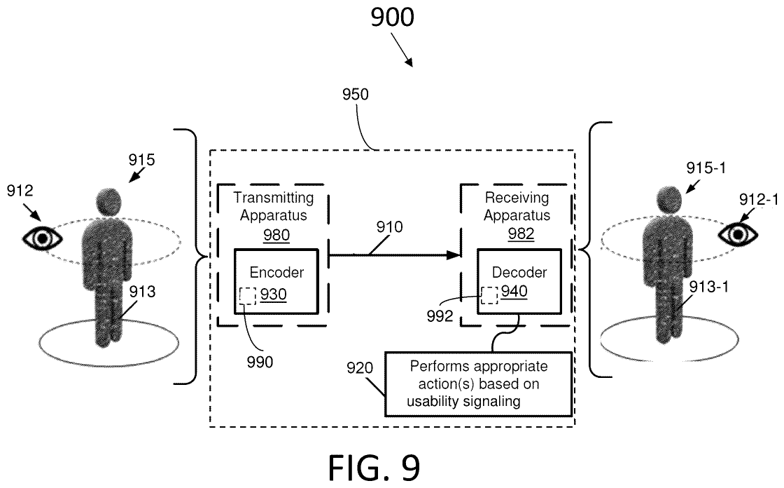

FIG. 9 is a block diagram illustrating a system 900 in accordance with several examples. In an example, the encoder 930 is used to encode an image or video from the scene 915, and the encoder 930 is implemented in a transmitting apparatus 980. The encoder 930 produces a bitstream 910 comprising signaling that is received by the receiving apparatus 982, which implements a decoder 940. The encoder 930 sends the bitstream 910 that comprises the herein described signaling. The decoder 940 forms the image or video for the scene 915-1, and the receiving apparatus 982 would present this to the user, e.g., via a smartphone, television, or projector among many other options.

In some examples, the transmitting apparatus 980 and the receiving apparatus 982 are at least partially within a common apparatus, and for example are located within a common housing 950. In other examples the transmitting apparatus 980 and the receiving apparatus 982 are at least partially not within a common apparatus and have at least partially different housings. Therefore in some examples, the encoder 930 and the decoder 940 are at least partially within a common apparatus, and for example are located within a common housing 950. For example the common apparatus comprising the encoder 930 and decoder 940 implements a codec. In other examples the encoder 930 and the decoder 940 are at least partially not within a common apparatus and have at least partially different housings, but when together still implement a codec.

In some examples, 3D media from the capture (e.g., volumetric capture) at a viewpoint 912 of the scene 915, which includes a person 913) is converted via projection to a series of 2D representations with occupancy, geometry, attributes and/or displacements. Additional atlas information is also included in the bitstream to enable inverse reconstruction. For decoding, the received bitstream 910 is separated into its components with atlas information; occupancy, geometry, displacement, and attribute 2D representations. A 3D reconstruction is performed to reconstruct the scene 915-1 created looking at the viewpoint 912-1 with a “reconstructed” person 913-1. The “−1” are used to indicate that these are reconstructions of the original. As indicated at 920, the decoder 940 performs an action or actions based on the received signaling.

Encoding 990 performs selection or determination of spatial merge candidates, based on the examples described herein. Decoding 992 performs selection or determination of spatial merge candidates, based on the examples described herein.

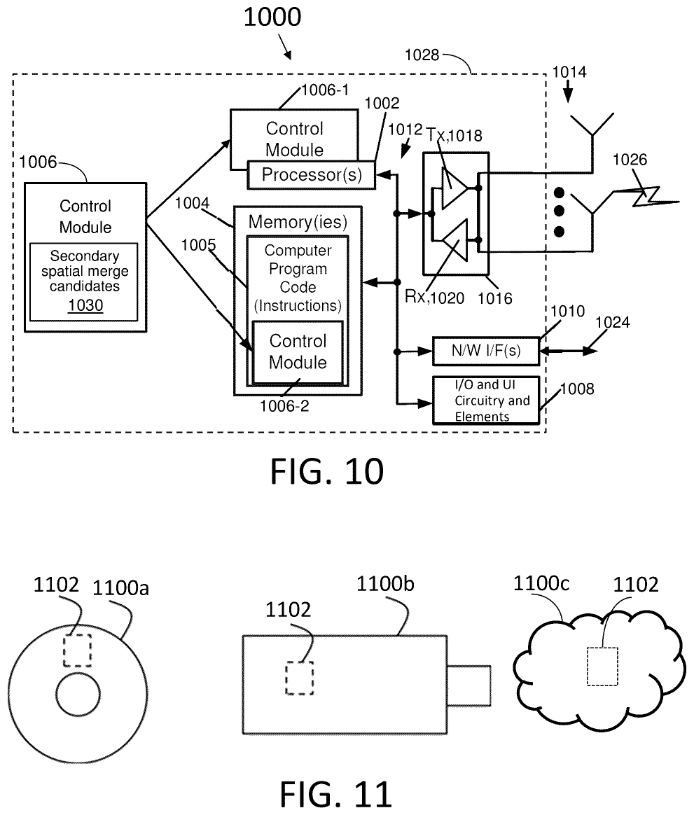

FIG. 10 is an example apparatus 1000, which may be implemented in hardware, configured to implement the examples described herein. The apparatus 1000 comprises at least one processor 1002 (e.g., an FPGA and/or CPU), one or more memories 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein.

Apparatus 1000 may be a smartphone, personal digital device or assistant, smart television, laptop, tablet, head-mounted display (HMD) or other user device or terminal device. The memory 1004 may be a non-transitory memory, a transitory memory, a volatile memory (e.g. RAM), or a non-volatile memory (e.g., ROM).

Secondary spatial merge candidates 1030 implements the examples described herein related to determination of secondary spatial merge candidates.

The apparatus 1000 includes a display and/or I/O interface 1008, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1010. The communication I/F(s) 1010 may be wired and/or wireless and communicate over the Internet/other network(s) via any communication technique including via one or more links 1024. The communication I/F(s) 1010 may comprise one or more transmitters or one or more receivers.

The transceiver 1016 comprises one or more transmitters 1018 and one or more receivers 1020. The transceiver 1016 and/or communication I/F(s) 1010 may comprise standard well-known components such as an amplifier, filter, frequency-converter, (de) modulator, and encoder/decoder circuitries and one or more antennas, such as antennas 1014 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the one or more processors 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the one or more processors 1002. For instance, the one or more memories 1004 store instructions that, when executed by the one or more processors 1002, cause the apparatus 1000 to perform one or more of the operations as described herein. Furthermore, the one or more processors 1002, one or more memories 1004, and example algorithms (e.g., as flowcharts and/or signaling diagrams), encoded as instructions, programs, or code, are means for causing performance of the operations described herein.

The apparatus 1000 to implement the functionality of control 1006 may correspond to any of the apparatuses depicted herein. Alternatively, apparatus 1000 and its elements may not correspond to any of the other apparatuses depicted herein, as apparatus 1000 may be part of a self-organizing/optimizing network (SON) node or other node, such as a node in a cloud.

The apparatus 1000 may also be distributed throughout the network including within and between apparatus 1000 and any network element (such as a base station and/or terminal device and/or user equipment).

Interface 1012 enables data communication and signaling between the various items of apparatus 1000, as shown in FIG. 10. For example, the interface 1012 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control 1006 may comprise object-oriented software configured to pass data or messages between objects within computer program code 1005. Computer program code (e.g. instructions) 1005, including control 1006 may comprise procedural, functional, or scripting code. The apparatus 1000 need not comprise each of the features mentioned, or may comprise other features as well. The various components of apparatus 1000 may at least partially reside in a common housing 1028, or a subset of the various components of apparatus 1000 may at least partially be located in different housings, which different housings may include housing 1028.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the operations of the methods described herein. Instructions and/or parameters 1102 may represent or correspond to a non-transitory computer readable medium.

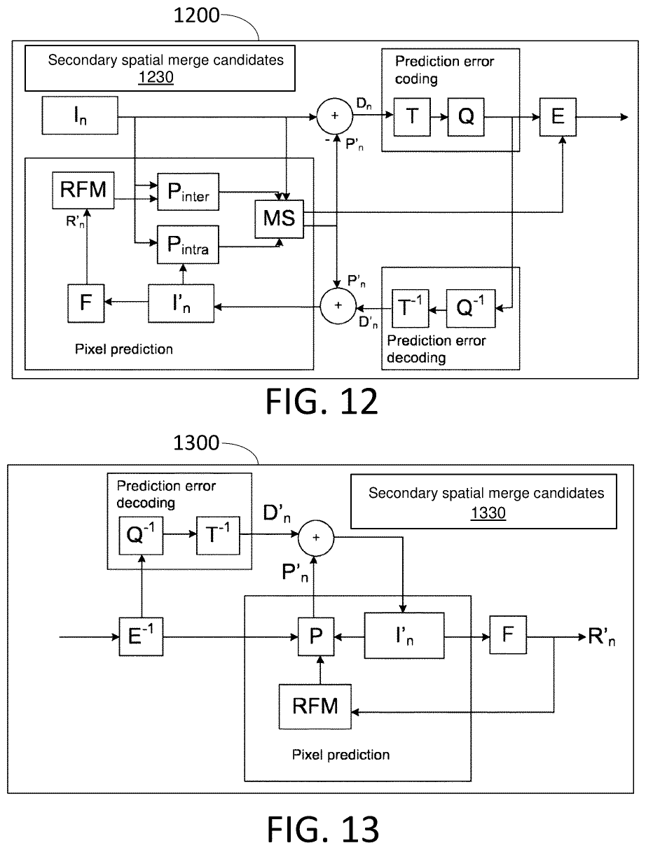

FIG. 12 shows an encoder 1200 according to an embodiment. FIG. 12 illustrates an image to be encoded (Iⁿ). a predicted representation of an image block (P′ⁿ), a prediction error signal (Dⁿ), a reconstructed prediction error signal (D′ⁿ). a preliminary reconstructed image (I′ⁿ), a final reconstructed image (R′ⁿ), a transform (T) and inverse transform (T⁻¹), a quantization (Q) and inverse quantization (Q⁻¹). entropy encoding (E). a reference frame memory (RFM), inter prediction (P^{inter}), intra prediction (P^{intra}), mode selection (MS) and filtering (F). Secondary spatial merge candidates 1230 implements the examples described herein related to determination of secondary spatial merge candidates.

FIG. 13 shows a decoder 1300 according to an embodiment. FIG. 13 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (cither inter or intra) (P), and filtering (F). Secondary spatial merge candidates 1330 implements the examples described herein related to determination of secondary spatial merge candidates.

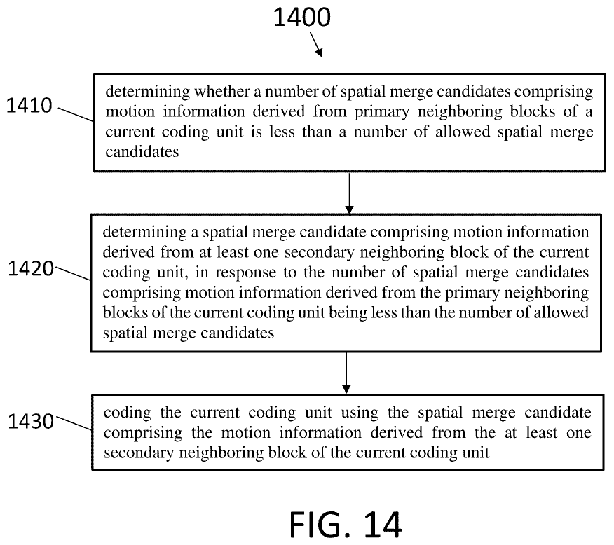

FIG. 14 is an example method 1400, based on the examples described herein. At 1410, the method includes determining whether a number of spatial merge candidates comprising motion information derived from primary neighboring blocks of a current coding unit is less than a number of allowed spatial merge candidates. At 1420, the method includes determining or selecting a spatial merge candidate comprising motion information derived from at least one secondary neighboring block of the current coding unit, in response to the number of spatial merge candidates comprising motion information derived from the primary neighboring blocks of the current coding unit being less than the number of allowed spatial merge candidates. At 1430, the method includes coding the current coding unit using the spatial merge candidate comprising the motion information derived from the at least one secondary neighboring block of the current coding unit. Method 1400 may be performed with apparatus 50, transmitting apparatus 980 with encoder 930, receiving apparatus 982 with decoder 940, apparatus 1000, encoder 1200 with secondary spatial merge candidates 1230, or decoder 1300 with secondary spatial merge candidates 1330.

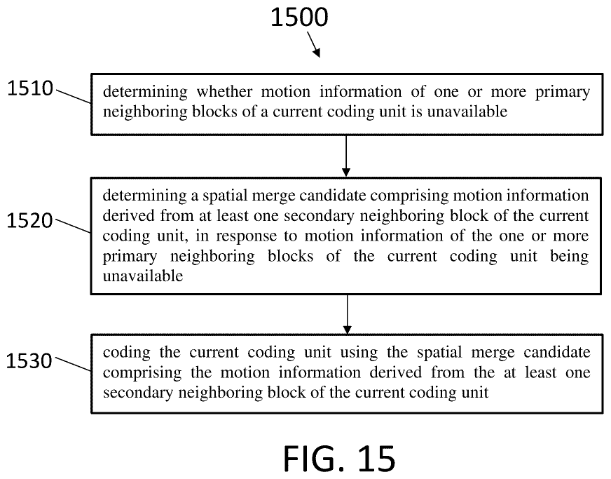

FIG. 15 is an example method 1500, based on the examples described herein. At 1510, the method includes determining whether motion information of one or more primary neighboring blocks of a current coding unit is unavailable. At 1520, the method includes determining a spatial merge candidate comprising motion information derived from at least one secondary neighboring block of the current coding unit, in response to motion information of the one or more primary neighboring blocks of the current coding unit being unavailable. At 1530, the method includes coding the current coding unit using the spatial merge candidate comprising the motion information derived from the at least one secondary neighboring block of the current coding unit. Method 1500 may be performed with apparatus 50, transmitting apparatus 980 with encoder 930, receiving apparatus 982 with decoder 940, apparatus 1000, encoder 1200 with secondary spatial merge candidates 1230, or decoder 1300 with secondary spatial merge candidates 1330.

The following examples are provided and described herein.

Example 1. An apparatus including: at least one processor; and at least one memory storing instructions that, when executed by the at least one processor, cause the apparatus at least to: determine whether a number of spatial merge candidates comprising motion information derived from primary neighboring blocks of a current coding unit is less than a number of allowed spatial merge candidates; determine a spatial merge candidate comprising motion information derived from at least one secondary neighboring block of the current coding unit, in response to the number of spatial merge candidates comprising motion information derived from the primary neighboring blocks of the current coding unit being less than the number of allowed spatial merge candidates; and code the current coding unit using the spatial merge candidate comprising the motion information derived from the at least one secondary neighboring block of the current coding unit.

Example 2. The apparatus of example 1, wherein: the motion information derived from the at least one secondary neighboring block of the current coding unit determined to be of the spatial merge candidate comprises unique motion information derived from the at least one secondary neighboring block; and the unique motion information derived from the at least one secondary neighboring block is different from motion information derived from one or more spatial merge candidates determined to be within a current set of the one or more spatial merge candidates.

Example 3. The apparatus of any of examples 1 to 2, wherein the instructions, when executed by the at least one processor, cause the apparatus at least to: include, within a list data structure, the spatial merge candidates comprising motion information derived from the primary neighboring blocks of the current coding unit.

Example 4. The apparatus of any of examples 1 to 3, wherein the instructions, when executed by the at least one processor, cause the apparatus at least to: include, within a list data structure, the spatial merge candidate comprising motion information derived from the at least one secondary neighboring block of the current coding unit.

Example 5. The apparatus of any of examples 1 to 4, wherein the instructions, when executed by the at least one processor, cause the apparatus at least to: determine whether there is at least one unique item of motion information of secondary neighboring blocks of the current coding unit, in response to the number of spatial merge candidates comprising motion information derived from the primary neighboring blocks of the current coding unit being less than the number of allowed spatial merge candidates; and determine that the spatial merge candidate is to comprise the at least one unique item of motion information of the secondary neighboring blocks of the current coding unit, in response to determining that there is at least one unique item of motion information of the secondary neighboring blocks of the current coding unit; wherein the determining of whether there is at least one unique item of motion information of the secondary neighboring blocks of the current coding unit is performed in a preset order of the secondary neighboring blocks.

Example 6. The apparatus of any of examples 1 to 5, wherein the instructions, when executed by the at least one processor, cause the apparatus at least to: determine whether two or more of the primary neighboring blocks of the current coding unit located at positions above the current coding unit are unavailable or are not coded in inter mode; determine whether there is at least one unique item of motion information of secondary neighboring blocks located at positions above the current coding unit, in response to the number of spatial merge candidates comprising motion information derived from the primary neighboring blocks of the current coding unit being less than the number of allowed spatial merge candidates, and in response to the two or more of the primary neighboring blocks of the current coding unit located at positions above the current coding unit being unavailable or not being coded in inter mode; and determine that the spatial merge candidate is to comprise the at least one unique item of motion information of the secondary neighboring blocks located at positions above the current coding unit, in response to determining that there is at least one unique item of motion information of the secondary neighboring blocks located at positions above the current coding unit; wherein the determining of whether there is at least one unique item of motion information of secondary neighboring blocks located at positions above the current coding unit is performed in a preset order of the secondary neighboring blocks located at positions above the current coding unit.

Example 7. The apparatus of any of examples 1 to 6, wherein the instructions, when executed by the at least one processor, cause the apparatus at least to: determine whether two or more of the primary neighboring blocks of the current coding unit located at positions left of the current coding unit are unavailable or are not coded in inter mode; determine whether there is at least one unique item of motion information of secondary neighboring blocks located at positions left of the current coding unit, in response to the number of spatial merge candidates comprising motion information derived from the primary neighboring blocks of the current coding unit being less than the number of allowed spatial merge candidates, and in response to the two or more of the primary neighboring blocks of the current coding unit located at positions left of the current coding unit being unavailable or not being coded in inter mode; and determine that the spatial merge candidate is to comprise the at least one unique item of motion information of the secondary neighboring blocks located at positions left of the current coding unit, in response to determining that there is at least one unique item of motion information of the secondary neighboring blocks located at positions left of the current coding unit; wherein the determining of whether there is at least one unique item of motion information of secondary neighboring blocks located at positions left of the current coding unit is performed in a preset order of the secondary neighboring blocks located at positions left of the current coding unit.

Example 8. The apparatus of any of examples 1 to 7, wherein the instructions, when executed by the at least one processor, cause the apparatus at least to: determine whether two or more of the primary neighboring blocks of the current coding unit located at positions above the current coding unit are unavailable or are not coded in inter mode; determine whether there is at least one unique item of motion information of secondary neighboring blocks located at positions above the current coding unit, in response to the number of spatial merge candidates comprising motion information derived from the primary neighboring blocks of the current coding unit being less than the number of allowed spatial merge candidates, and in response to the two or more of the primary neighboring blocks of the current coding unit located at positions above the current coding unit being unavailable or not being coded in inter mode; and determine that the spatial merge candidate is to comprise the at least one unique item of motion information of the secondary neighboring blocks located at positions above the current coding unit, in response to determining that there is at least one unique item of motion information of the secondary neighboring blocks located at positions above the current coding unit; wherein the determining of whether there is at least one unique item of motion information of secondary neighboring blocks located at positions above the current coding unit is performed in an order of the secondary neighboring blocks located at positions above the current coding unit.

Example 9. The apparatus of example 8, wherein the determining of whether there is at least one unique item of motion information of secondary neighboring blocks located at positions above the current coding unit is performed in an order of the secondary neighboring blocks located at positions above the current coding unit from right to left, the order comprising beginning at a secondary neighboring block located at a position immediately to the left of a primary neighboring block located at an above position relative to the current coding unit, and ending at a secondary neighboring block located at a position immediately to the right of a primary neighboring block located at an above-left position relative to the current coding unit.

Example 10. The apparatus of any of examples 8 to 9, wherein the determining of whether there is at least one unique item of motion information of secondary neighboring blocks located at positions above the current coding unit is performed in an order of the secondary neighboring blocks located at positions above the current coding unit from left to right, the order comprising beginning at a secondary neighboring block located at a position immediately to the right of a primary neighboring block located at an above-left position relative to the current coding unit and ending at a secondary neighboring block located at a position immediately to the left of a primary neighboring block located at an above position relative to the current coding unit.

Example 11. The apparatus of any of examples 8 to 10, wherein the instructions, when executed by the at least one processor, cause the apparatus at least to: determine whether there is at least one unique item of motion information of secondary neighboring blocks located at positions left of the current coding unit, in response to determining that there is not at least one unique item of motion information of the secondary neighboring blocks located at positions above the current coding unit; and determine that the spatial merge candidate is to comprise the at least one unique item of motion information of the secondary neighboring blocks located at positions left of the current coding unit, in response to determining that there is at least one unique item of motion information of the secondary neighboring blocks located at positions left of the current coding unit.

Example 12. The apparatus of example 11, wherein the determining of whether there is at least one unique item of motion information of secondary neighboring blocks located at positions left of the current coding unit is performed in a preset order of the secondary neighboring blocks located at positions left of the current coding unit.

Example 13. The apparatus of any of examples 1 to 12, wherein the instructions, when executed by the at least one processor, cause the apparatus at least to: determine whether two or more of the primary neighboring blocks of the current coding unit located at positions left of the current coding unit are unavailable or are not coded in inter mode; determine whether there is at least one unique item of motion information of secondary neighboring blocks located at positions left of the current coding unit, in response to the number of spatial merge candidates comprising motion information derived from the primary neighboring blocks of the current coding unit being less than the number of allowed spatial merge candidates, and in response to the two or more of the primary neighboring blocks of the current coding unit located at positions left of the current coding unit being unavailable or not being coded in inter mode; and determine that the spatial merge candidate is to comprise the at least one unique item of motion information of the secondary neighboring blocks located at positions left of the current coding unit, in response to determining that there is at least one unique item of motion information of the secondary neighboring blocks located at positions left of the current coding unit; wherein the determining of whether there is at least one unique item of motion information of secondary neighboring blocks located at positions left of the current coding unit is performed in order of the secondary neighboring blocks located at positions left of the current coding unit.

Example 14. The apparatus of example 13, wherein the determining of whether there is at least one unique item of motion information of secondary neighboring blocks located at positions left of the current coding unit is performed in order of the secondary neighboring blocks located at positions left of the current coding unit from bottom to top, the order comprising beginning at a secondary neighboring block located at a position immediately above a primary neighboring block located at left position relative to the current coding unit, and ending at a secondary neighboring block located at a position immediately below a primary neighboring block located at an above-left position relative to the current coding unit.

Example 15. The apparatus of any of examples 13 to 14, wherein the determining of whether there is at least one unique item of motion information of secondary neighboring blocks located at positions left of the current coding unit is performed in order of the secondary neighboring blocks located at positions left of the current coding unit from top to bottom, the order comprising beginning at a secondary neighboring block located at a position immediately below a primary neighboring block located at an above-left position relative to the current coding unit, and ending at a secondary neighboring block located at a position immediately above a primary neighboring block located at left position relative to the current coding unit.

Example 16. The apparatus of any of examples 13 to 15, wherein the instructions, when executed by the at least one processor, cause the apparatus at least to: determine whether there is at least one unique item of motion information of secondary neighboring blocks located at positions above the current coding unit, in response to determining that there is not at least one unique item of motion information of the secondary neighboring blocks located at positions left of the current coding unit; and determine that the spatial merge candidate is to comprise the at least one unique item of motion information of the secondary neighboring blocks located at positions above the current coding unit, in response to determining that there is at least one unique item of motion information of the secondary neighboring blocks located at positions above the current coding unit.

Example 17. The apparatus of example 16, wherein the determining of whether there is at least one unique item of motion information of secondary neighboring blocks located at positions above the current coding unit is performed in a preset order of the secondary neighboring blocks located at positions above the current coding unit.

Example 18. The apparatus of any of examples 1 to 17, wherein the instructions, when executed by the at least one processor, cause the apparatus at least to: determine whether two or more of the primary neighboring blocks of the current coding unit located at positions above the current coding unit are unavailable or are not coded in inter mode; determine whether there is at least one unique item of motion information of secondary neighboring blocks located at positions above the current coding unit, in response to the number of spatial merge candidates comprising motion information derived from the primary neighboring blocks of the current coding unit being less than the number of allowed spatial merge candidates, and in response to the two or more of the primary neighboring blocks of the current coding unit located at positions above the current coding unit being unavailable or not being coded in inter mode; and determine that the spatial merge candidate is to comprise the at least one unique item of motion information of the secondary neighboring blocks located at positions above the current coding unit, in response to determining that there is at least one unique item of motion information of the secondary neighboring blocks located at positions above the current coding unit; wherein the determining of whether there is at least one unique item of motion information of secondary neighboring blocks located at positions above the current coding unit is performed in order of the secondary neighboring blocks located at positions above the current coding unit, the order comprising beginning at a middle secondary neighboring block in the middle of a primary neighboring block located at an above position relative to the current coding unit and a primary neighboring block located at an above-left position relative to the coding unit, extending to other secondary neighboring blocks above the current coding unit on both the left and right sides of the middle secondary neighboring block alternately.

Example 19. The apparatus of example 18, wherein the instructions, when executed by the at least one processor, cause the apparatus at least to: determine whether there is at least one unique item of motion information of secondary neighboring blocks located at positions left of the current coding unit, in response to determining that there is not at least one unique item of motion information of the secondary neighboring blocks located at positions above the current coding unit; and determine that the spatial merge candidate is to comprise the at least one unique item of motion information of the secondary neighboring blocks located at positions left of the current coding unit, in response to determining that there is at least one unique item of motion information of the secondary neighboring blocks located at positions left of the current coding unit.

Example 20. The apparatus of any of examples 18 to 19, wherein the instructions, when executed by the at least one processor, cause the apparatus at least to: determine whether a number of secondary neighboring blocks between the primary neighboring block located at the above position relative to the current coding unit and the primary neighboring block located at the above-left position relative to the coding unit is even; determine a first value as the number of secondary neighboring blocks between the primary neighboring block located at the above position relative to the current coding unit and the primary neighboring block located at the above-left position relative to the coding unit divided by 2, in response to there being an even number of secondary neighboring blocks between the primary neighboring block located at the above position relative to the current coding unit and the primary neighboring block located at the above-left position relative to the coding unit; and determine a second value as the number of secondary neighboring blocks between the primary neighboring block located at the above position relative to the current coding unit and the primary neighboring block located at the above-left position relative to the coding unit divided by 2 plus 1, in response to there being an even number of secondary neighboring blocks between the primary neighboring block located at the above position relative to the current coding unit and the primary neighboring block located at the above-left position relative to the coding unit; wherein the middle secondary neighboring block comprises a secondary neighboring block located a number of positions to the left of the primary neighboring block located at the above position relative to the current coding unit, the number of positions comprising the first value or the second value, when there are an even number of secondary neighboring blocks between the primary neighboring block located at the above position relative to the current coding unit and the primary neighboring block located at the above-left position relative to the coding unit.

Example 21. The apparatus of any of examples 1 to 20, wherein the instructions, when executed by the at least one processor, cause the apparatus at least to: determine whether two or more of the primary neighboring blocks of the current coding unit located at positions left of the current coding unit are unavailable or are not coded in inter mode; determine whether there is at least one unique item of motion information of secondary neighboring blocks located at positions left of the current coding unit, in response to the number of spatial merge candidates comprising motion information derived from the primary neighboring blocks of the current coding unit being less than the number of allowed spatial merge candidates, and in response to the two or more of the primary neighboring blocks of the current coding unit located at positions left of the current coding unit being unavailable or not being coded in inter mode; and determine that the spatial merge candidate is to comprise the at least one unique item of motion information of the secondary neighboring blocks located at positions left of the current coding unit, in response to determining that there is at least one unique item of motion information of the secondary neighboring blocks located at positions left of the current coding unit; wherein the determining of whether there is at least one unique item of motion information of secondary neighboring blocks located at positions left of the current coding unit is performed in order of the secondary neighboring blocks located at positions left of the current coding unit, the order comprising beginning at a middle secondary neighboring block in the middle of a primary neighboring block located at a left position relative to the current coding unit and a primary neighboring block located at an above-left position relative to the coding unit, extending to other secondary neighboring blocks left of the current coding unit both above and below the middle secondary neighboring block alternately.

Example 22. The apparatus of example 21, wherein the instructions, when executed by the at least one processor, cause the apparatus at least to: determine whether there is at least one unique item of motion information of secondary neighboring blocks located at positions above the current coding unit, in response to determining that there is not at least one unique item of motion information of the secondary neighboring blocks located at positions left of the current coding unit; and determine that the spatial merge candidate is to comprise the at least one unique item of motion information of the secondary neighboring blocks located at positions above the current coding unit, in response to determining that there is at least one unique item of motion information of the secondary neighboring blocks located at positions above the current coding unit.

Example 23. The apparatus of any of examples 21 to 22, wherein the instructions, when executed by the at least one processor, cause the apparatus at least to: determine whether a number of secondary neighboring blocks between the primary neighboring block located at the left position relative to the current coding unit and the primary neighboring block located at the above-left position relative to the coding unit is even; determine a first value as the number of secondary neighboring blocks between the primary neighboring block located at the left position relative to the current coding unit and the primary neighboring block located at the above-left position relative to the coding unit divided by 2, in response to there being an even number of secondary neighboring blocks between the primary neighboring block located at the left position relative to the current coding unit and the primary neighboring block located at the above-left position relative to the coding unit; and determine a second value as the number of secondary neighboring blocks between the primary neighboring block located at the left position relative to the current coding unit and the primary neighboring block located at the above-left position relative to the coding unit divided by 2 plus 1, in response to there being an even number of secondary neighboring blocks between the primary neighboring block located at the left position relative to the current coding unit and the primary neighboring block located at the above-left position relative to the coding unit; wherein the middle secondary neighboring block comprises a secondary neighboring block located a number of positions above the primary neighboring block located at the left position relative to the current coding unit, the number of positions comprising the first value or the second value, when there are an even number of secondary neighboring blocks between the primary neighboring block located at the left position relative to the current coding unit and the primary neighboring block located at the above-left position relative to the coding unit.

Example 24. The apparatus of any of examples 1 to 23, wherein the number of spatial merge candidates comprising motion information derived from the primary neighboring blocks is zero, such that no spatial merge candidates comprise motion information derived from the primary neighboring blocks.

Example 25. The apparatus of any of examples 1 to 24, wherein the primary neighboring blocks comprise: a block at an above position relative to the current coding unit, and a block at a left position relative to the current coding unit, and a block at an above-right position relative to the current coding unit, and a block at a bottom-left position relative to the current coding unit, and a block at an above-left position relative to the current coding unit.

Example 26. The apparatus of example 25, wherein: the block at the above position relative to the current coding unit is to the right of the block at the above-left position relative to the current coding unit, and the block at the above position relative to the current coding unit is to the left of the block above-right position relative to the current coding unit, and the block at the left position relative to the current coding unit is above the block at the bottom-left position relative to the current coding unit, and the block at the left position relative to the current coding unit is below the block at the above-left position relative to the current coding unit.

Example 27. The apparatus of any of examples 25 to 26, wherein the at least one secondary neighboring block comprises: a block at a position left of the current coding unit, above the block at the left position relative to the current coding unit, and below the block at the above-left position relative to the current coding unit, or a block at a position above the current coding unit, to the right of the block at the above-left position relative to the current coding unit, and to the left of the block at the above position relative to the current coding unit.

Example 28. The apparatus of any of examples 1 to 27, wherein a number of secondary neighboring blocks above the current coding unit is equal to a width of the current coding unit divided with a width of the at least one secondary neighboring block.

Example 29. The apparatus of any of examples 1 to 28, wherein a number of secondary neighboring blocks left of the current coding unit is equal to a height of the current coding unit divided with a height of the at least one secondary neighboring block.

Example 30. The apparatus of any of examples 1 to 29, wherein an encoder comprises the apparatus, or the apparatus comprises an encoder.

Example 31. The apparatus of any of examples 1 to 30, wherein a decoder comprises the apparatus, or the apparatus comprises a decoder.

Example 32. A method including: determining whether a number of spatial merge candidates comprising motion information derived from primary neighboring blocks of a current coding unit is less than a number of allowed spatial merge candidates; determining a spatial merge candidate comprising motion information derived from at least one secondary neighboring block of the current coding unit, in response to the number of spatial merge candidates comprising motion information derived from the primary neighboring blocks of the current coding unit being less than the number of allowed spatial merge candidates; and coding the current coding unit using the spatial merge candidate comprising the motion information derived from the at least one secondary neighboring block of the current coding unit.

Example 33. An apparatus including: means for determining whether a number of spatial merge candidates comprising motion information derived from primary neighboring blocks of a current coding unit is less than a number of allowed spatial merge candidates; means for determining a spatial merge candidate comprising motion information derived from at least one secondary neighboring block of the current coding unit, in response to the number of spatial merge candidates comprising motion information derived from the primary neighboring blocks of the current coding unit being less than the number of allowed spatial merge candidates; and means for coding the current coding unit using the spatial merge candidate comprising the motion information derived from the at least one secondary neighboring block of the current coding unit.

Example 34. A computer readable medium including instructions stored thereon for performing at least the following: determining whether a number of spatial merge candidates comprising motion information derived from primary neighboring blocks of a current coding unit is less than a number of allowed spatial merge candidates; determining a spatial merge candidate comprising motion information derived from at least one secondary neighboring block of the current coding unit, in response to the number of spatial merge candidates comprising motion information derived from the primary neighboring blocks of the current coding unit being less than the number of allowed spatial merge candidates; and coding the current coding unit using the spatial merge candidate comprising the motion information derived from the at least one secondary neighboring block of the current coding unit.

Example 35. An apparatus including: at least one processor; and at least one memory storing instructions that, when executed by the at least one processor, cause the apparatus at least to: determine whether motion information of one or more primary neighboring blocks of a current coding unit is unavailable; determine a spatial merge candidate comprising motion information derived from at least one secondary neighboring block of the current coding unit, in response to motion information of the one or more primary neighboring blocks of the current coding unit being unavailable; and code the current coding unit using the spatial merge candidate comprising the motion information derived from the at least one secondary neighboring block of the current coding unit.

Example 36. A method including: determining whether motion information of one or more primary neighboring blocks of a current coding unit is unavailable; determining a spatial merge candidate comprising motion information derived from at least one secondary neighboring block of the current coding unit, in response to motion information of the one or more primary neighboring blocks of the current coding unit being unavailable; and coding the current coding unit using the spatial merge candidate comprising the motion information derived from the at least one secondary neighboring block of the current coding unit.

Example 37. An apparatus including: means for determining whether motion information of one or more primary neighboring blocks of a current coding unit is unavailable; means for determining a spatial merge candidate comprising motion information derived from at least one secondary neighboring block of the current coding unit, in response to motion information of the one or more primary neighboring blocks of the current coding unit being unavailable; and means for coding the current coding unit using the spatial merge candidate comprising the motion information derived from the at least one secondary neighboring block of the current coding unit.

Example 38. A computer readable medium including instructions stored thereon for performing at least the following: determining whether motion information of one or more primary neighboring blocks of a current coding unit is unavailable; determining a spatial merge candidate comprising motion information derived from at least one secondary neighboring block of the current coding unit, in response to motion information of the one or more primary neighboring blocks of the current coding unit being unavailable; and coding the current coding unit using the spatial merge candidate comprising the motion information derived from the at least one secondary neighboring block of the current coding unit.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (−), or number (or abbreviations having a character may be the same with a character removed), and may be case insensitive):
2D two-dimensional
3D three-dimensional
A0 left neighboring block
A1 bottom-left neighboring block
AB above-left neighboring block
ASIC application specific integrated circuit
B0 above neighboring block
B1 above-right neighboring block
CPU central processing unit
CTU coding tree unit
CU coding unit
ECM enhanced compression model
FPGA field programmable gate array
HMD head-mounted display
HMVP history-based motion vector prediction
IBC intra block copy
I/F interface
I/O input/output
JVET joint video experts team
m number of left secondary neighboring blocks
MVD motion vector delta
MVP motion vector prediction
n number of above secondary neighboring blocks
N/W network
RAM random access memory
RFM reference frame memory
ROM read only memory
SON self-organizing/optimizing network
UI user interface
USB universal serial bus
VVC versatile video coding

What is claimed is:

1. An apparatus comprising:
at least one processor; and
at least one memory storing instructions that, when executed by the at least one processor, cause the apparatus at least to:
determine whether a number of spatial merge candidates comprising motion information derived from primary neighboring blocks of a current coding unit is less than a number of allowed spatial merge candidates;
determine a spatial merge candidate comprising motion information derived from at least one secondary neighboring block of the current coding unit, when the number of spatial merge candidates comprising the motion information derived from the primary neighboring blocks of the current coding unit being less than the number of allowed spatial merge candidates; and
code the current coding unit using the spatial merge candidate comprising the motion information derived from the at least one secondary neighboring block of the current coding unit.

2. The apparatus of claim 1, wherein:
the motion information derived from the at least one secondary neighboring block of the current coding unit comprises unique motion information derived from the at least one secondary neighboring block; and
the unique motion information derived from the at least one secondary neighboring block is different from motion information derived from one or more spatial merge candidates determined to be within a current set of the one or more spatial merge candidates.

3. The apparatus of claim 1, wherein the instructions, when executed by the at least one processor, cause the apparatus at least to:
include, within a list data structure, the spatial merge candidates comprising the motion information derived from the primary neighboring blocks of the current coding unit.

4. The apparatus of claim 1, wherein the instructions, when executed by the at least one processor, cause the apparatus at least to:
include, within a list data structure, the spatial merge candidate comprising the motion information derived from the at least one secondary neighboring block of the current coding unit.

5. The apparatus of claim 1, wherein the instructions, when executed by the at least one processor, cause the apparatus at least to:
determine whether there is at least one unique item of motion information of secondary neighboring blocks of the current coding unit, when the number of spatial merge candidates comprising motion information derived from the primary neighboring blocks of the current coding unit being less than the number of allowed spatial merge candidates; and
determine that the spatial merge candidate comprises the at least one unique item of motion information of the secondary neighboring blocks of the current coding unit, when there is at least one unique item of motion information of the secondary neighboring blocks of the current coding unit;
wherein the determining whether there is at least one unique item of motion information of the secondary neighboring blocks of the current coding unit is performed in a preset order of the secondary neighboring blocks.

6. The apparatus of claim 1, wherein the instructions, when executed by the at least one processor, cause the apparatus at least to:
determine whether two or more of the primary neighboring blocks of the current coding unit located at positions above the current coding unit are unavailable or are not coded in inter mode;
determine whether there is at least one unique item of motion information of secondary neighboring blocks located at positions above the current coding unit, when the number of spatial merge candidates comprising motion information derived from the primary neighboring blocks of the current coding unit being less than the number of allowed spatial merge candidates, and when the two or more of the primary neighboring blocks of the current coding unit located at positions above the current coding unit being unavailable or not being coded in inter mode; and
determine that the spatial merge candidate comprises the at least one unique item of motion information of the secondary neighboring blocks located at positions above the current coding unit, when determining that there is at least one unique item of motion information of the secondary neighboring blocks located at positions above the current coding unit;
wherein the determining of whether there is the at least one unique item of motion information of secondary neighboring blocks located at positions above the current coding unit is performed in a preset order of the secondary neighboring blocks located at positions above the current coding unit.

7. The apparatus of claim 1, wherein the instructions, when executed by the at least one processor, cause the apparatus at least to:
determine whether two or more of the primary neighboring blocks of the current coding unit located at positions left of the current coding unit are unavailable or are not coded in inter mode;
determine whether there is at least one unique item of motion information of secondary neighboring blocks located at positions left of the current coding unit, when the number of spatial merge candidates comprising motion information derived from the primary neighboring blocks of the current coding unit being less than the number of allowed spatial merge candidates, and when the two or more of the primary neighboring blocks of the current coding unit located at positions left of the current coding unit being unavailable or not being coded in inter mode; and
determine that the spatial merge candidate is to comprise the at least one unique item of motion information of the secondary neighboring blocks located at positions left of the current coding unit, when determining that there is at least one unique item of motion information of the secondary neighboring blocks located at positions left of the current coding unit;
wherein the determining of whether there is the at least one unique item of motion information of secondary neighboring blocks located at positions left of the current coding unit is performed in a preset order of the secondary neighboring blocks located at positions left of the current coding unit.

8. The apparatus of claim 1, wherein the instructions, when executed by the at least one processor, cause the apparatus at least to:
determine whether two or more of the primary neighboring blocks of the current coding unit located at positions left of the current coding unit are unavailable or are not coded in inter mode;
determine whether there is at least one unique item of motion information of secondary neighboring blocks located at positions left of the current coding unit, when the number of spatial merge candidates comprising motion information derived from the primary neighboring blocks of the current coding unit being less than the number of allowed spatial merge candidates, and when the two or more of the primary neighboring blocks of the current coding unit located at positions left of the current coding unit being unavailable or not being coded in inter mode; and
determine that the spatial merge candidate is to comprise the at least one unique item of motion information of the secondary neighboring blocks located at positions left of the current coding unit, when determining that there is at least one unique item of motion information of the secondary neighboring blocks located at positions left of the current coding unit;
wherein the determining of whether there is the at least one unique item of motion information of secondary neighboring blocks located at positions left of the current coding unit is performed in one of the following:
an order of the secondary neighboring blocks located at positions left of the current coding unit.
an order of the secondary neighboring blocks located at positions left of the current coding unit from bottom to top, wherein the order comprising beginning at a secondary neighboring block located at a position immediately above a primary neighboring block located at left position relative to the current coding unit, and ending at a secondary neighboring block located at a position immediately below a primary neighboring block located at an above-left position relative to the current coding unit.
an order of the secondary neighboring blocks located at positions left of the current coding unit from top to bottom, wherein the order comprising beginning at a secondary neighboring block located at a position immediately below a primary neighboring block located at the above-left position relative to the current coding unit, and ending at a secondary neighboring block located at a position immediately above a primary neighboring block located at the left position relative to the current coding unit.

9. The apparatus of claim 8, wherein the instructions, when executed by the at least one processor, cause the apparatus at least to:
determine whether there is at least one unique item of motion information of secondary neighboring blocks located at positions above the current coding unit, when determining that there is not at least one unique item of motion information of the secondary neighboring blocks located at positions left of the current coding unit;
determine that the spatial merge candidate is to comprise the at least one unique item of motion information of the secondary neighboring blocks located at positions above the current coding unit, when determining that there is at least one unique item of motion information of the secondary neighboring blocks located at positions above the current coding unit; and
wherein the determining of whether there is the at least one unique item of motion information of secondary neighboring blocks located at positions above the current coding unit is performed in a preset order of the secondary neighboring blocks located at positions above the current coding unit.

10. The apparatus of claim 1, wherein the instructions, when executed by the at least one processor, cause the apparatus at least to:
determine whether two or more of the primary neighboring blocks of the current coding unit located at positions above the current coding unit are unavailable or are not coded in inter mode;
determine whether there is at least one unique item of motion information of secondary neighboring blocks located at positions above the current coding unit, when the number of spatial merge candidates comprising motion information derived from the primary neighboring blocks of the current coding unit being less than the number of allowed spatial merge candidates, and when the two or more of the primary neighboring blocks of the current coding unit located at positions above the current coding unit being unavailable or not being coded in inter mode; and
determine that the spatial merge candidate is to comprise the at least one unique item of motion information of the secondary neighboring blocks located at positions above the current coding unit, when determining that there is at least one unique item of motion information of the secondary neighboring blocks located at positions above the current coding unit;
wherein the determining of whether there is the at least one unique item of motion information of secondary neighboring blocks located at positions above the current coding unit is performed in order of the secondary neighboring blocks located at positions above the current coding unit, the order comprising beginning at a middle secondary neighboring block in the middle of a primary neighboring block located at an above position relative to the current coding unit and a primary neighboring block located at an above-left position relative to the current coding unit, extending to other secondary neighboring blocks above the current coding unit on both left and right sides of the middle secondary neighboring block alternately.
determine whether there is the at least one unique item of motion information of secondary neighboring blocks located at positions left of the current coding unit, when determining that there is not at least one unique item of motion information of the secondary neighboring blocks located at positions above the current coding unit; and
determine that the spatial merge candidate is to comprise the at least one unique item of motion information of the secondary neighboring blocks located at positions left of the current coding unit, when determining that there is at least one unique item of motion information of the secondary neighboring blocks located at positions left of the current coding unit.
determine whether a number of secondary neighboring blocks between the primary neighboring block located at the above position relative to the current coding unit and the primary neighboring block located at the above-left position relative to the coding unit is even;
determine a first value as the number of secondary neighboring blocks between the primary neighboring block located at the above position relative to the current coding unit and the primary neighboring block located at the above-left position relative to the coding unit divided by 2, when there being an even number of secondary neighboring blocks between the primary neighboring block located at the above position relative to the current coding unit and the primary neighboring block located at the above-left position relative to the coding unit;
determine a second value as the number of secondary neighboring blocks between the primary neighboring block located at the above position relative to the current coding unit and the primary neighboring block located at the above-left position relative to the coding unit divided by 2 plus 1, when there being the even number of secondary neighboring blocks between the primary neighboring block located at the above position relative to the current coding unit and the primary neighboring block located at the above-left position relative to the coding unit; and
wherein the middle secondary neighboring block comprises a secondary neighboring block located a number of positions to the left of the primary neighboring block located at the above position relative to the current coding unit, the number of positions comprising the first value or the second value, when there are the even number of secondary neighboring blocks between the primary neighboring block located at the above position relative to the current coding unit and the primary neighboring block located at the above-left position relative to the coding unit.

11. The apparatus of claim 1, wherein the instructions, when executed by the at least one processor, cause the apparatus at least to:
determine whether two or more of the primary neighboring blocks of the current coding unit located at positions left of the current coding unit are unavailable or are not coded in inter mode;
determine whether there is at least one unique item of motion information of secondary neighboring blocks located at positions left of the current coding unit, when the number of spatial merge candidates comprising motion information derived from the primary neighboring blocks of the current coding unit being less than the number of allowed spatial merge candidates, and when the two or more of the primary neighboring blocks of the current coding unit located at positions left of the current coding unit being unavailable or not being coded in inter mode; and
determine that the spatial merge candidate is to comprise the at least one unique item of motion information of the secondary neighboring blocks located at positions left of the current coding unit, when determining that there is at least one unique item of motion information of the secondary neighboring blocks located at positions left of the current coding unit;
wherein the determining of whether there is the at least one unique item of motion information of secondary neighboring blocks located at positions left of the current coding unit is performed in order of the secondary neighboring blocks located at positions left of the current coding unit, the order comprising beginning at a middle secondary neighboring block in the middle of a primary neighboring block located at a left position relative to the current coding unit and a primary neighboring block located at an above-left position relative to the coding unit, extending to other secondary neighboring blocks left of the current coding unit both above and below the middle secondary neighboring block alternately.

12. The apparatus of claim 1, wherein the instructions, when executed by the at least one processor, cause the apparatus at least to:
determine whether there is the at least one unique item of motion information of secondary neighboring blocks located at positions above the current coding unit, when determining that there is not at least one unique item of motion information of the secondary neighboring blocks located at positions left of the current coding unit;
determine that the spatial merge candidate is to comprise the at least one unique item of motion information of the secondary neighboring blocks located at positions above the current coding unit, when determining that there is at least one unique item of motion information of the secondary neighboring blocks located at positions above the current coding unit;
determine whether a number of secondary neighboring blocks between the primary neighboring block located at the left position relative to the current coding unit and the primary neighboring block located at the above-left position relative to the coding unit is even;
determine a first value as the number of secondary neighboring blocks between the primary neighboring block located at the left position relative to the current coding unit and the primary neighboring block located at the above-left position relative to the coding unit divided by 2, when there being an even number of secondary neighboring blocks between the primary neighboring block located at the left position relative to the current coding unit and the primary neighboring block located at the above-left position relative to the coding unit;
determine a second value as the number of secondary neighboring blocks between the primary neighboring block located at the left position relative to the current coding unit and the primary neighboring block located at the above-left position relative to the coding unit divided by 2 plus 1, when there being the even number of secondary neighboring blocks between the primary neighboring block located at the left position relative to the current coding unit and the primary neighboring block located at the above-left position relative to the coding unit; and
wherein the middle secondary neighboring block comprises a secondary neighboring block located a number of positions above the primary neighboring block located at the left position relative to the current coding unit, the number of positions comprising the first value or the second value, when there are the even number of secondary neighboring blocks between the primary neighboring block located at the left position relative to the current coding unit and the primary neighboring block located at the above-left position relative to the coding unit.

13. The apparatus of claim 1, wherein the number of spatial merge candidates comprising motion information derived from the primary neighboring blocks is zero, such that no spatial merge candidates comprise motion information derived from the primary neighboring blocks.

14. The apparatus of claim 1, wherein the primary neighboring blocks comprise:
a block at an above position relative to the current coding unit, and
a block at a left position relative to the current coding unit, and
a block at an above-right position relative to the current coding unit, and
a block at a bottom-left position relative to the current coding unit, and
a block at an above-left position relative to the current coding unit;

15. The apparatus of claim 14, wherein:
the block at the above position relative to the current coding unit is to the right of the block at the above-left position relative to the current coding unit, and the block at the above position relative to the current coding unit is to the left of the block at the above-right position relative to the current coding unit, and
the block at the left position relative to the current coding unit is above the block at the bottom-left position relative to the current coding unit, and the block at the left position relative to the current coding unit is below the block at the above-left position relative to the current coding unit.

16. The apparatus of claim 15, wherein the at least one secondary neighboring block comprises:
the block at the position left of the current coding unit, above the block at the left position relative to the current coding unit, and below the block at the above-left position relative to the current coding unit, or
the block at the position above the current coding unit, to the right of the block at the above-left position relative to the current coding unit, and to the left of the block at the above position relative to the current coding unit.

17. The apparatus of claim 1, wherein a number of secondary neighboring blocks above the current coding unit is equal to a width of the current coding unit divided with a width of the at least one secondary neighboring block.

18. The apparatus of claim 1, wherein a number of secondary neighboring blocks left of the current coding unit is equal to a height of the current coding unit divided with a height of the at least one secondary neighboring block.

19. A method comprising:
determining whether a number of spatial merge candidates comprising motion information derived from primary neighboring blocks of a current coding unit is less than a number of allowed spatial merge candidates;
determining a spatial merge candidate comprising motion information derived from at least one secondary neighboring block of the current coding unit, when the number of spatial merge candidates comprising motion information derived from the primary neighboring blocks of the current coding unit being less than the number of allowed spatial merge candidates; and
coding the current coding unit using the spatial merge candidate comprising the motion information derived from the at least one secondary neighboring block of the current coding unit.

20. An apparatus comprising:
at least one processor; and
at least one memory storing instructions that, when executed by the at least one processor, cause the apparatus at least to:
determine whether motion information of one or more primary neighboring blocks of a current coding unit is unavailable;
determine a spatial merge candidate comprising motion information derived from at least one secondary neighboring block of the current coding unit, when motion information of the one or more primary neighboring blocks of the current coding unit being unavailable; and
code the current coding unit using the spatial merge candidate comprising the motion information derived from the at least one secondary neighboring block of the current coding unit.

21. A method comprising:
determining whether motion information of one or more primary neighboring blocks of a current coding unit is unavailable;
determining a spatial merge candidate comprising motion information derived from at least one secondary neighboring block of the current coding unit, when motion information of the one or more primary neighboring blocks of the current coding unit being unavailable; and
coding the current coding unit using the spatial merge candidate comprising the motion information derived from the at least one secondary neighboring block of the current coding unit.
